(19) United States
(12) Patent Application Publication
(10) Pub. No.: US 2004/0087698 A1
(43) Pub. Date: May 6, 2004

(54) Products incorporating luminescent sealants

(75) Inventors: Theodore A. Wegert, Louisville, KY (US); Karen Cary, Louisville, KY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Corporation, Yonkers, NY

(21) Appl. No.: 10/685,890

(22) Filed: Oct. 14, 2003

Related U.S. Application Data
(60) Provisional application No. 60/418,412, filed on Oct. 15, 2002.

(51) Int. Cl. C08K 3/10; C09D 5/29

(52) U.S. Cl. 524/436; 523/171

(57) ABSTRACT

A sealant having luminescent properties for use on various industrial and household products is provided. One luminescent sealant includes a sealant, such as RTV sealant, mixed with a thermoluminescent pigment. When applied to a surface, this thermoluminescent sealant emits light in response to a change in the surface's temperature. Preferably, a change in color of the sealant accompanies the emission of light to warn those who may come in contact with a hot surface on which the sealant is applied. Another luminescent sealant is provided mixed with a photoluminescent pigment to produce a photoluminescent effect. This photoluminescent sealant absorbs and emits light energy. The light produced by the sealant is useful to indicate the location of a product in a darkened environment, or to verify whether the sealant has been properly applied on the product.

### CROSS REFERENCE TO RELATED APPLICATION

This application claims the benefit of U.S. Provisional Patent Application No. 60/418,412, filed Oct. 15, 2002, which is incorporated by reference herein as if fully set forth.

### BACKGROUND

The present invention is directed to the use of luminescent sealants in products, and in particular to appliances.

It has been known to make a component of a product from a photoluminescent material or to include a photoluminescent coating on the product to provide a “glow-in-the-dark” feature. However, this was typically done by including a photoluminescent pigment in the material, such as plastic, from which a component was molded, or by coating, which added a separate step of painting with the photoluminescent paint. This either added cost by requiring an additional step in production, or needed to be done at the component manufacturing level well in advance of assembly of the product, which limited the flexibility of whether or not to incorporate this feature.

Many products require sealants and/or adhesives as part of their structure. These include home appliances, consumer products, and other types of products, such as those used in connection with vehicles and boats. It would be beneficial to be able to add additional properties to these known required materials, such as photoluminescence, as desired and in a flexible manner during the production process in order to achieve additional functionality or special effects.

### SUMMARY

The present invention provides a novel sealant having luminescent properties for use on various industrial and household products. A luminescent sealant emits light in response to certain external stimulus.

In a first aspect of the invention, the luminescent sealant includes a conventional sealant, such as RTV (room temperature vulcanizing) sealant, mixed with a thermoluminescent pigment, such as a chlorophane-based pigment. When applied to a surface, this thermoluminescent sealant emits light in response to a change in the surface's temperature. Preferably, a change in color of the sealant accompanies the emission of light to warn those who may come in contact with a hot surface on which the sealant is applied.

In another aspect of the invention, a conventional sealant is mixed with a photoluminescent pigment, such as a strontium or silicon aluminate-based pigment, to produce a photoluminescent sealant. This photoluminescent sealant absorbs and emits light energy and may replace conventional sealants on a variety of surfaces. The light produced by the sealant is useful to indicate the location of a product in a darkened environment, or to verify whether the sealant has been properly applied on that product.

### BRIEF DESCRIPTION OF THE DRAWINGS

FIG. 1 is a flow diagram of a method of applying and inspecting a sealant in accordance with the present invention.

FIG. 2a is a perspective view of a cooktop in accordance with the present invention.

FIG. 2b is a perspective view of the cooktop of FIG. 2a with sealant applied in a heating area visable.

### DETAILED DESCRIPTION OF THE PREFERRED EMBODIMENTS

The present invention is directed to the use of luminescent sealants in products. Such products may include kitchen appliances, bathroom appliances and fixtures, and other household appliances such as a hot water heater, furnace, or washers and dryers. Further applications include residential or commercial windows, door-frames, and siding, as well as applications in automobiles, boats, airplanes, and other vehicles.

In a first embodiment, a sealant, such as RTV silicone, is mixed with a thermoluminescent pigment, for example a chlorophane-based pigment, which emits light after absorbing energy from a heat source. Such sealant is usable with surfaces that may get hot. In a preferred embodiment, the sealant is visible to the end user. Generally, the sealant with the thermoluminescent pigment is used as an indicator to warn the end user that the surface to which the sealant is adhered to is hot to the touch. Such sealants may be used with surfaces that are heated, such as glass ceramic cooktops and hot plates. Additionally, such sealants are also usable in the engine compartments of vehicles, especially in the areas where an end user or mechanic may be accidentally exposed to the hot surfaces. Such sealants may also be used in, on, around or in connection with products that can become hot due to sun exposure, such as door-handles on automobiles, boats and other vehicles. The thermo-luminescent pigment can also be used in refractive sealants in areas such as fireplaces, water-heater, flues, ductwork, and other residential or commercial areas. Generally, the sealant may be clear, or white, or contain an opaque pigment to match the adhering surface, and would further comprise a thermoluminescent pigment which turns a different color when exposed to heat. Due to the perception that hot things tend to be red, the use of a pigment that generates a red color is preferred.

In another embodiment of the invention, an RTV sealant is mixed together with a photoluminescent pigment, for example, strontium-based pigment and/or silicon aluminate-based pigment, which emits light after absorbing light from another light source. This can provide the benefit during production of identifying sealants on surfaces that are visible to the end user. As sealant colors can be made to match the color of the underlying surface, it is easier for a manufacturer to overlook misapplication of sealants during production and inspections of the product. The photoluminescent sealant would stand out during inspection, either by turning off the light or by applying radiation at a particular reactive wave length, such as UV (ultraviolet) light. Once an inappropriate placement of the sealant is detected, the necessary cleaning or reworking of the product can be performed.

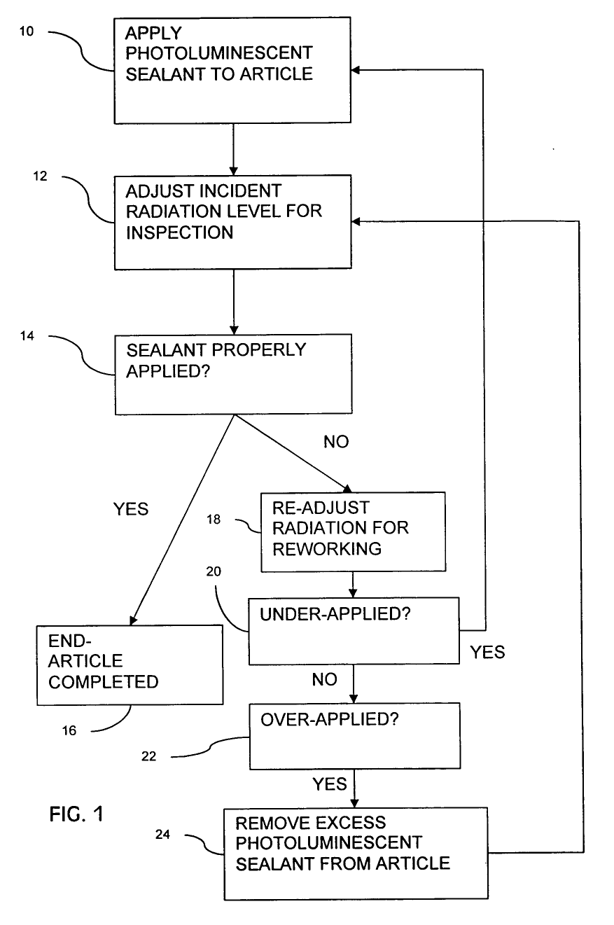

Making reference to FIG. 1, a flow chart is provided which sets forth a method for application and inspection of photoluminescent sealant on an article. In an application step 10, photoluminescent sealant is applied to an article in accordance with a predetermined requirement. Subsequently, in a radiation adjustment step 12, a level of radiation incident on the article is adjusted. By way of example, the step 12 may include a reduction of a level of light radiation such that an inspection technician may view the sealant in an illuminated state without interference from other light sources. Alternatively, if a UV sensitive sealant is applied to the article, the step 12 may include increasing a level of UV light incident on the article to allow illumination and/or color change of the applied sealant.

In an inspection step 14, an inspector, or an inspection device, observes the illuminated or color modified sealant as applied on the article. If the sealant is properly applied with reference to the predetermined requirement, a completion step 16 indicates that the article is properly sealed and complete. If the sealant is not properly applied, levels of radiation are adjusted in a radiation re-adjustment step 18 such that the environment is conducive for reworking of the article. In the case of manual reworking, the incident light would need to be increased and/or the UV radiation would need to be reduced. In the case of machine reworking of the article, the radiation adjustment steps 12, 18 may possibly be omitted and a constant level of radiation conducive for inspection may be maintained.

If it is determined in a step 20 that the sealant is under-applied, a return to the application step 10 is effected, and additional sealant is applied where necessary. If it is determined in a step 22 that the sealant is over-applied, in a removal step 24 excess sealant is removed from the article, and a return to the radiation adjustment step 12 is effected. Again, once it is determined in the inspection step 14, that the sealant has been applied properly, the article is complete.

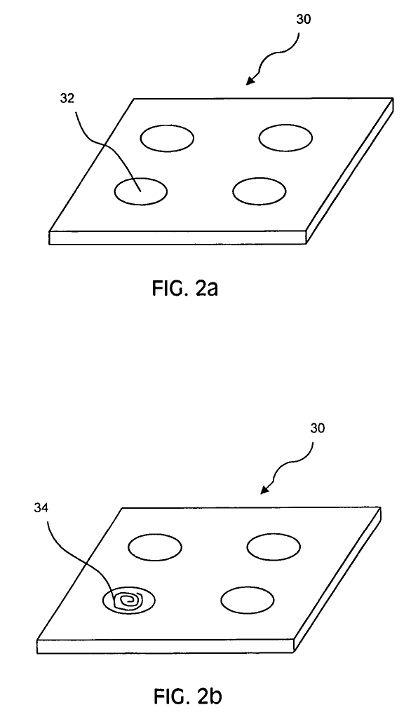

In addition to production and inspection applications, the photoluminescent sealant could also be used for an aesthetic or visual effect in a product, without the need for additional parts or processes if a sealant is applied in any case, such as around a glass-ceramic cooktop. For example, a glass-ceramic cooktop is sealed to a support structure, and the use of a photoluminescent sealant can serve as a night light to provide a spatial reference in a dark room, or could be applied in a decorative pattern or logo in addition to sealing the edges. This could provide a unique look in a glass-ceramic cooktop where a pattern or logo is applied to the underside of the cooktop, and can then be seen through the cooktop when the lights are off (in the case of a photoluminescent sealant) or when the cooktop is heated (in the case of a thermoluminescent sealant). FIGS. 2a and 2b show such a cooktop 30 having heating areas 32. Each of the areas 32 includes an amount of thermoluminescent sealant 34 applied in a suitable pattern beneath a surface of the cooktop 30 for viewing through one of the areas 32. When one of the heating areas 32 is activated, elevating its temperature, the thermoluminescent sealant illuminates to warn a user that the particular heating area is hot. Alternatively, item 34 may represent applied photoluminescent sealant permitting areas 32 to be illuminated when light is removed from the cooktop.

The photoluminescent or thermoluminescent pigment can be added to the sealant during its original formulation, or can be mixed in just prior to dispensing, for example, through a mixing head. This adds additional visual features to the existing sealing or adhesive.

Special high intensity graphics or visual effects can be provided using special or controlled illumination, for example using fiber optic light sources.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention.

What is claimed is:

1. A luminescent sealant comprising a sealant material and at least one luminescent pigment therein.

2. The luminescent sealant according to claim 1, wherein the sealant material is RTV silicone.

3. The luminescent sealant according to claim 1, wherein the luminescent pigment is a thermoluminescent pigment.

4. The luminescent sealant according to claim 3, wherein the thermoluminescent pigment is chlorophane-based.

5. The luminescent sealant according to claim 3, wherein the thermoluminescent pigment is a color changing pigment whereby the pigment changes color upon exposure to heat.

6. The luminescent sealant according to claim 1, wherein the sealant material is substantially clear.

7. The luminescent sealant according to claim 1, wherein the luminescent pigment is photoluminescent.

8. The luminescent sealant according to claim 7, wherein the photoluminescent pigment is strontium-based.

9. The luminescent sealant according to claim 7, wherein the photoluminescent pigment is silicon aluminate-based.

10. The luminescent sealant according to claim 7, wherein the photoluminescent pigment is strontium-based and silicon aluminate-based.

11. The luminescent sealant according to claim 7, wherein the photoluminescent pigment is UV reactive.

12. The luminescent sealant according to claim 7, wherein the photoluminescent pigment is a color changing pigment whereby the pigment changes color upon a change in incident radiation.

13. A method for producing a luminescent sealant comprising mixing a sealant material with a luminescent pigment.

14. The method of claim 13, wherein the step of mixing the sealant material and the luminescent pigment includes mixing the sealant material with a photoluminescent pigment.

15. The method of claim 13, wherein the step of mixing the sealant material and the luminescent pigment includes mixing the sealant material with a thermoluminescent pigment.

16. A method for obtaining temperature information of a surface, the method comprising;
applying a thermoluminescent sealant to the surface;
observing the applied sealant for changes in coloration due to the application of heat.

17. The method according to claim 16, wherein the step of applying includes applying the thermoluminescent sealant to an appliance having at least one heating area.

18. A method for inspecting an article having sealant applied thereto, comprising:
applying photoluminescent sealant to the article in accordance with a predetermined requirement;
adjusting a level of incident radiation on the article having the sealant applied thereto such that the sealant is illuminated;
observing illumination of the photoluminescent sealant; and
at least one of adding or removing the photoluminescent sealant on the article, in response to the observed illumination, to meet the predetermined requirement.

19. The method according to claim 18, wherein the step of applying includes applying a photoluminescent sealant having an RTV sealant mixed with a photoluminescent pigment.

20. The method according to claim 18, wherein the step of applying includes applying a photoluminescent sealant comprising a sealant material mixed with one of a strontium-based pigment and an aluminate-based pigment.

21. The method according to claim 18, wherein the step of adjusting the level of incident radiation includes decreasing an amount of visable light incident on the article.

22. The method according to claim 18, wherein the step of adjusting the level of incident radiation includes increasing an amount of UV radiation incident on the article.

23. An appliance comprising at least one luminescent sealant applied thereto.

24. The appliance according to claim 23, wherein the luminescent sealant is a photoluminescent sealant.

25. The appliance according to claim 23, wherein the luminescent sealant is a thermoluminescent sealant.

26. The appliance according to claim 25, further comprising at least one heating area, wherein the thermoluminescent sealant is applied in proximity to the heating area, whereby the sealant illuminates with a change in temperature of the heating area.

27. The appliance according to claim 25, further comprising at least one heating area, wherein the thermoluminescent sealant is applied in proximity to the heating area, whereby the sealant changes color with a change in temperature of the heating area.
